(19) United States
(12) Patent Application Publication
(10) Pub. No.: US 2020/0122231 A1
(43) Pub. Date: Apr. 23, 2020

(54) POWDER CANISTER AND METHOD FOR MANUFACTURING SAME

(71) Applicant: Aurora Labs Limited, Bibra Lake, Western Australia (AU)

(72) Inventor: Robert Phillip Brown, Bibra Lake, Western Australia (AU)

(73) Assignee: Aurora Labs Limited, Bibra Lake, Western Australia (AU)

(21) Appl. No.: 16/619,794

(22) PCT Filed: Jun. 6, 2018
(86) PCT No.: PCT/AU2018/000091

§ 371 Date: Dec. 5, 2019

(30) Foreign Application Priority Data
Jun. 6, 2017 (AU) 2017902154

(51) Int. Cl. B22F 3/105; B29C 64/153; B22F 5/10; B65D 85/00

(52) U.S. Cl. CPC B22F 3/1055; B29C 64/153; B33Y 10/00; B65D 85/70; B22F 5/10

(57) ABSTRACT

A method for manufacturing a powder-containing canister, including: (a) using a powder dispenser to deposit layers of powder onto an operative surface; (b) emitting an energy beam onto the layers to melt the powder in the layers and form a partially-formed body of the canister having an internal cavity; (c) using the powder dispenser to deposit powder into the internal cavity; (d) using the powder dispenser to deposit further layers of powder onto the partially-formed body; and (e) emitting an energy beam onto the further layers to melt the powder in the further layers and form a complete body of the canister, thereby sealing the powder in the internal cavity.

### FIELD OF INVENTION

The present invention relates to powder-containing canisters and more particularly, but not exclusively, powder-containing canisters for use with three-dimensional (3D) printers.

### BACKGROUND

Powders are used in a wide variety of industrial fabrication processes. Metal powders, in particular, are used in additive fabrication processes such as 3D printing.

3D printers typically operate by having a powder bed onto which an energy beam is projected to melt the top layer of the powder bed so that it welds onto a substrate or a substratum. This melting process is repeated to add additional powder layers to the substratum to incrementally build up the part until completely fabricated.

Powders used with 3D printers are typically supplied in canisters that, in use, are connected to the printer. The powder is made separately from the canister and is inserted into the canister after the canister has been formed. This is time consuming and requires separate machinery to manufacture each of the canister and powder.

Further, to operate effectively 3D printers need to use powders that are of a high-quality and comprise powder particles that are consistent in composition, form and their properties. Powders that are stored in known canisters often degrade over time, for example due to exposure to moisture and other adverse environmental conditions.

Further, after a powder canister has been manufactured and put into the supply chain, it is difficult to keep track of information about the canister and powder contained therein which may be required by end users. This includes, for example, information regarding the composition of the powder, the date of manufacture and/or use by date of the powder and the identity of the manufacturer of the canister and powder.

It is an object of the present invention to provide a powder-containing canister and method for manufacturing the same that, at least in part, ameliorates and overcomes these problems.

### SUMMARY OF THE INVENTION

In accordance with one aspect of the present invention, there is provided a method for manufacturing a powder-containing canister, the method comprising:
(a) using a powder dispenser to deposit layers of powder onto an operative surface;
(b) emitting an energy beam onto the layers to melt the powder in the layers and form a partially-formed body of the canister having an internal cavity;
(c) using the powder dispenser to deposit powder into the internal cavity;
(d) using the powder dispenser to deposit further layers of powder onto the partially-formed body; and
(e) emitting an energy beam onto the further layers to melt the powder in the further layers and form a complete body of the canister, thereby sealing the powder in the internal cavity.

The powder may be deposited into the internal cavity after side walls of the canister's body have been formed in full.

The powder may be deposited into the internal cavity while the side walls of the body are being formed.

The powder may be deposited into the internal cavity intermittently while the side walls of the body are being formed.

The powder may be deposited into the internal cavity continuously while the side walls of the body are being formed.

In accordance with one further aspect of the invention, there is provided a canister for containing powder, the canister comprising:
a body having an internal cavity for containing powder and at least one aperture formed in the body;
a connection means for releasably connecting the canister to a 3D printing apparatus; and
a membrane covering the aperture for sealing the powder in the canister,
   whereby the membrane is configured to be pierced by a part of the 3D printing apparatus when the canister is connected thereto for allowing powder to be supplied from the canister to the 3D printing apparatus.

The connection means may be configured such that the aperture of the canister aligns with a complementary aperture in the 3D printing apparatus when the canister is connected thereto.

The canister body may have a Radio-Frequency Identification (RFID) chip attached to the body for storing data relating to the canister and powder contained therein.

The canister body may have a plurality of marks etched into an external surface of the body, wherein the marks encode data relating to the canister and powder contained therein.

The canister body and membrane of the canister and the powder contained in the canister may be made of metal.

### BRIEF DESCRIPTION OF DRAWINGS

The present invention will now be described, by way of example, with reference to the accompanying drawings, in which:

FIGS. 1 to 3 illustrate steps comprised in a method for manufacturing a powder-containing canister according to an embodiment of the invention;

FIG. 4 shows a partial enlarged view of a powder-containing canister manufactured using the method illustrated in FIGS. 1 to 3; and

FIG. 5 shows a powder-containing canister manufactured using the method illustrated in FIGS. 1 to 3, wherein the canister is shown connected to a 3D printing apparatus.

### DETAILED DESCRIPTION OF THE DRAWINGS

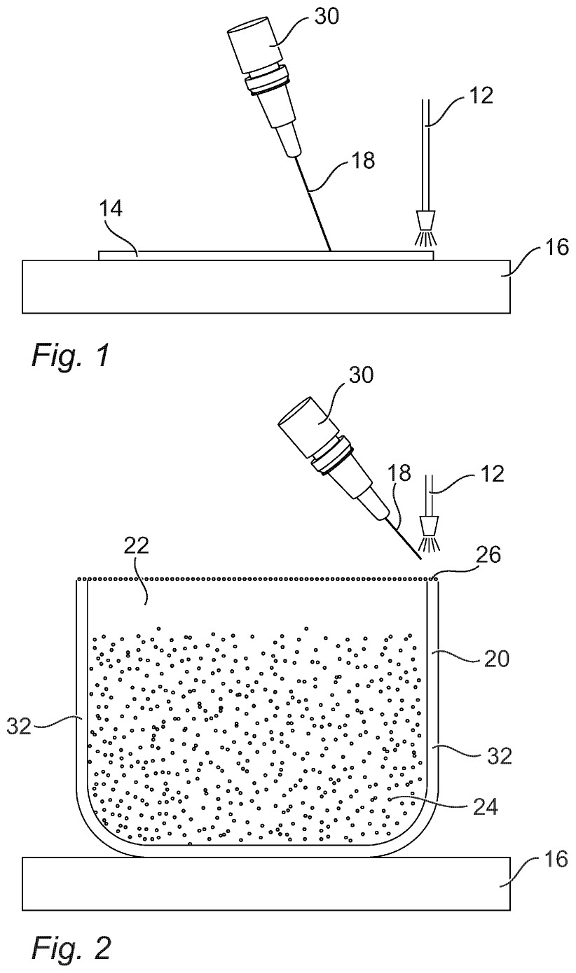

Referring to FIGS. 1 to 3, there is illustrated a method for manufacturing a powder-containing canister 10, the method comprising:
(a) using a powder dispenser 12 to deposit layers of powder 14 onto an operative surface 16;
(b) emitting an energy beam 18 onto the layers 14 to melt the powder in the layers 14 and form a partially-formed body 20 of the canister 10 having an internal cavity 22;
(c) using the powder dispenser 12 to deposit powder 24 into the internal cavity 22;
(d) using the powder dispenser 12 to deposit further layers of powder 26 onto the partially-formed body 20; and
(e) emitting an energy beam 18 onto the further layers 26 to melt the powder in the further layers 26 and form a complete body 28 of the canister 10 thereby sealing the powder 24 in the internal cavity 22.

More particularly, referring to FIG. 1 the powder dispenser 12 is initially used to deposit a first layer of powder 14 onto the operative surface 16. The energy beam 18 is then emitted using an energy source 30 onto the layer 14 to melt the powder in the layer 14 which, once solidified, forms part of the body 20 of the canister 10.

Additional layers of powder are then deposited and melted to build up incrementally further parts of the body 20, as shown in FIG. 2.

The energy beam 18 can be any one of a laser beam, a collimated light beam, a micro-plasma welding arc, an electron beam and a particle accelerator. Preferably, the energy beam 18 has focusing means (not shown) being adapted to suitably focus the energy beam 18 so that an energy density being at least 10 Watts/mm³ is produced. Where the energy beam 18 is a laser beam, the laser beam can be focused onto the operative surface 16 to a spot size of less than 0.5 mm². Similarly, where the energy beam 18 is a collimated light beam, the light beam can be focused onto the operative surface 16 to a spot size of less than 1 mm². Further, where the energy beam 18 is a micro-plasma welding arc, the micro-plasma welding arc can be focused onto the operative surface 16 to a spot size of less than 1 mm². Such a micro-plasma welding arc is normally able to produce a focused beam of plasma gas at a temperature of about 20,000° C. with a spot size of about 0.2 mm².

As shown in FIG. 2, the partially-formed body 20 of the canister 10 that is created has an internal cavity 22. The powder dispenser 12 is then used to deposit powder 24 into the internal cavity 22. In one embodiment, the powder 24 may be deposited into the internal cavity 22 after side walls 32 of the body 20 have been formed in full.

Alternatively, the powder 24 may be deposited into the internal cavity 22 while the side walls 32 of the body 20 are being formed. In such embodiments, the powder 24 may be deposited into the internal cavity 22 continuously or intermittently while the side walls 32 of the body 20 are being formed.

The powder 24 that is deposited into the internal cavity 22 is not melted by the energy source 30 and thereby constitutes the powder that the canister 10, once fully manufactured, serves to contain.

After the powder 24 is deposited, the powder dispenser 12 is then used to deposit further layers of powder 26 onto the body 20 and the energy source 30 is used to emit an energy beam 18 onto the further layers 26 to melt the powder in the layers 26 and form a complete body 28 of the canister 10, as shown in FIG. 3. The powder 24 is thereby sealed hermetically within the canister 10 when the body 28 is completed.

The disclosed method may be used to “print” powder-containing canisters made from a variety of different materials. It will be understood that the material(s) comprised in the powder used to fabricate the canister 10 will determine the material(s) comprised in the body 28 and powder 24 stored therein. For example, using a metal-based powder in the method will result in the production of a metal body 28 containing metal powder 24. Alternatively, a plastic-based powder will result in the production of a plastic body 28 containing plastic powder 24.

The finished canister 10 is suitable for use with additive fabrication processes including, in particular, 3D printing.

The method advantageously enables powder-containing canisters to be manufactured using a single 3D printing apparatus. A separate source and supply of powder is not, therefore, required to manufacture the canister 10.

The method also advantageously allows the powder 24 to be sealed hermetically inside the container 10 as part of the manufacturing process. Exposure to moisture and other adverse environmental conditions is, therefore, minimised.

Referring to FIG. 3, in accordance with one further aspect of the invention there is provided a canister 10 for containing powder, the canister 10 comprising a body 28 having an internal cavity for containing powder and at least one aperture 34 formed in the body 28. The canister 10 further comprises a connection means 36 for releasably connecting the canister 10 to a 3D printing apparatus 37 and a membrane 38 covering the aperture 34 for sealing the powder in the canister 10. The membrane 38 is configured to be pierced or unsealed by a part of the 3D printing apparatus 37 when the canister 10 is connected thereto for allowing powder to be supplied from the canister 10 to the 3D printing apparatus.

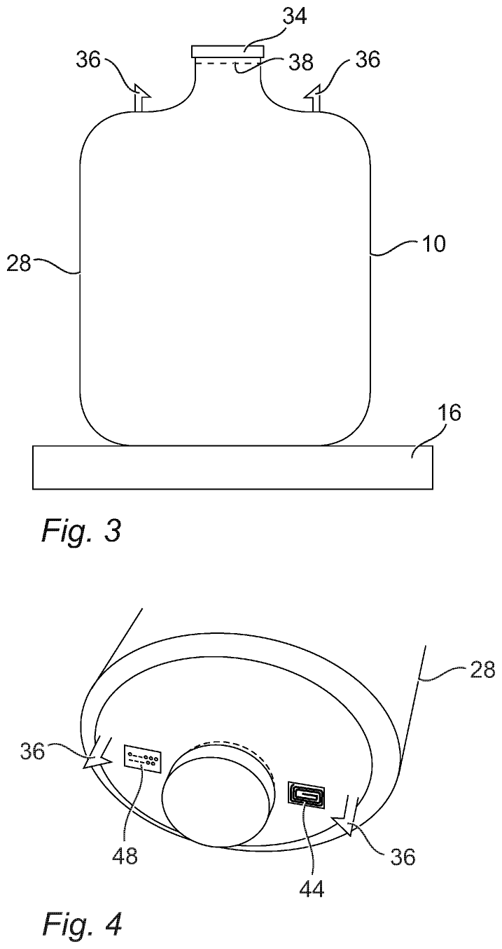

More particularly, as shown in FIG. 4 the connection means 36 comprises a pair of barbed clips extending from the canister 10. The clips are flexible and configured to mate with a pair of complementary indents on the 3D printing apparatus 37 for releasably connecting the canister 10 to the 3D printing apparatus 37.

Alternative connection means may be used such as flange, barbs, lugs, clamps or other means that are apparent to those skilled in the art.

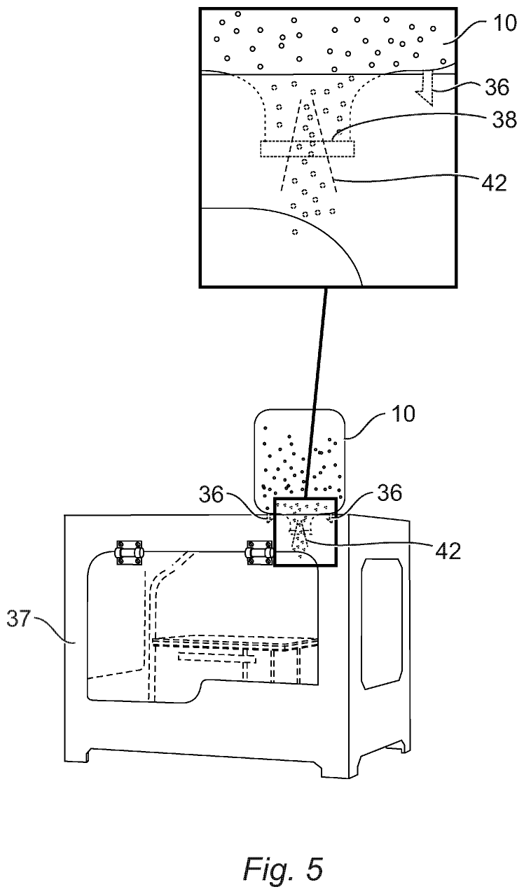

Referring to FIG. 5, there is shown the canister 10 connected releasably to the 3D printing apparatus 37. The connection means 36 is, preferably, configured such that the aperture 34 of the canister 10 aligns with a complementary aperture in the 3D printing apparatus 37 when the canister 10 is connected thereto.

The 3D printing apparatus 37 comprises an elongate nozzle 42 which is configured to pierce the membrane 38 covering the canister's 10 aperture 34 when the canister 10 is pressed down and onto the 3D printing apparatus 37 when being connected.

Alternative means may be used to unseal the membrane 38.

The membrane 38 advantageously provides that the powder contained in the canister 10 is sealed therein and can only be extracted from the canister when the canister 10 is connected to the 3D printing apparatus 37.

As shown in FIG. 4, the body 28 of the canister 10 may also have a Radio-Frequency Identification (RFID) chip 44 attached to the body 28. The RFID chip 44 stores various data relating to the canister 10 and powder contained therein. These data may include, for example, information regarding the composition of the powder in the canister 10, the date of manufacture and/or the use by date of the canister 10 and powder or the identity of the manufacturer of the canister 10 and powder.

The RFID chip 44 is, preferably, positioned on the body 28 such that it substantially aligns with a complementary RFID reader device (not shown) on the 3D printing apparatus 37 when the canister 10 is connected thereto. This allows the reader device to retrieve the data encoded in the RFID chip 44. These data can then be used by control logic embedded in the 3D printing apparatus 37 to control the manufacture of products created using the powder in the canister 10.

In addition to, or as an alternative to the RFID chip 44, the body 28 of the canister 10 may have a plurality of marks 48 etched into an external surface of the body 28. The marks 48 are similarly used to encode data relating to the canister 10 and powder contained therein. Any suitable encoding scheme may be used to create the marks 48. For example, a series of dots and dashes may be etched into the body 28 encoding the data in binary form.

The marks 48 are, preferably, positioned on the body 28 such that they substantially align with a complementary reader device (not shown) on the 3D printing apparatus 37 when the canister 10 is connected thereto.

Modifications and variations as would be apparent to a skilled addressee are deemed to be within the scope of the present invention.

In the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

1. A method for manufacturing a powder-containing canister, the method comprising the steps of:
a. using a powder dispenser to deposit layers of powder onto an operative surface;
b. emitting an energy beam onto the layers to melt the powder in the layers and form a partially-formed body of the canister having an internal cavity;
c. using the powder dispenser to deposit powder into the internal cavity;
d. using the powder dispenser to deposit further layers of powder onto the partially-formed body; and
e. emitting an energy beam onto the further layers to melt the powder in the further layers and form a complete body of the canister, thereby sealing the powder in the internal cavity.

2. The method for manufacturing a powder-containing canister according to claim 1, whereby the powder is deposited into the internal cavity after side walls of the canister's body have been formed in full.

3. The method for manufacturing a powder-containing canister according to claim 1, whereby the powder is deposited into the internal cavity while the side walls of the body are being formed.

4. The method for manufacturing a powder-containing canister according to claim 3, whereby the powder is deposited into the internal cavity intermittently.

5. The method for manufacturing a powder-containing canister according to claim 3, whereby the powder is deposited into the internal cavity continuously.

6.-14. (canceled)
